(19) United States
(12) Patent Application Publication
(10) Pub. No.: US 2022/0225816 A1
(43) Pub. Date: Jul. 21, 2022

(54) APPARATUS AND SYSTEM FOR PREPARING AN ICED TEA OR COFFEE BEVERAGE

(71) Applicant: Koninklijke Douwe Egberts B.V., Utrecht (NL)

(72) Inventors: Koen Standaar, Utrecht (NL); Zwaantje Kroondijk, Utrecht (NL); Dennis Kemp, Nieuw Vennep (NL); Boris Franzen, Nieuw Vennep (NL)

(21) Appl. No.: 17/615,031

(22) PCT Filed: May 11, 2020
(86) PCT No.: PCT/EP2020/062990

§ 371 Date: Nov. 29, 2021

(30) Foreign Application Priority Data
May 30, 2019 (GB) 1907691.8

(51) Int. Cl. A47J 31/41; A47J 31/44; F25D 31/00

(52) U.S. Cl. CPC A47J 31/41; A47J 31/4403; F25D 2303/084; F25D 2331/806; F25D 31/003

(57) ABSTRACT

Apparatus and system for preparing an ice-containing tea or coffee beverage. The apparatus (300) comprising a beverage concentrate reservoir (360), a sweetener concentrate reservoir (361) and a water pre-chiller (312). A first pre-mixer (362) for mixing beverage concentrate supplied from the beverage concentrate reservoir with water supplied from the water pre-chiller, a second pre-mixer (363) for mixing sweetener concentrate supplied from the sweetener concentrate reservoir with water supplied from the water pre-chiller. A mixing chamber (364) for mixing an output from the first pre-mixer with an output from the second pre-mixer to form a beverage liquor, a cooling unit (310). An ice-generating system (311), a beverage product circuit for supplying the beverage liquor from the mixing chamber to the ice-generating system and a cooling circuit for supplying coolant from the cooling unit to the ice-generating system to cool the beverage liquor and to thereby form a plurality of ice crystals within the beverage liquor. A beverage dispensing outlet (303) is also provided.

### TECHNICAL FIELD

This disclosure relates to iced coffee and tea beverages, an apparatus for making the beverages and a system using the apparatus. In particular, the disclosure relates to an aerated ice beverage with a creamy mouthfeel and a long stability once prepared.

### BACKGROUND

It is well known to provide consumers with ice in their beverages to provide greater refreshment. Beyond simply adding ice-cubes, it is well known to provide beverages such as Slush-puppie® style drinks made by constantly agitating a strongly refrigerated beverage concentrate. Such scraped beverages contain small rough ice fragments and have a slurry-like mouthfeel for the consumer.

Alternatively, beverages may be produced by blending ice cubes with a beverage liquor to produce a beverage with ice flakes distributed therein. This relies on a high speed blender having cutting blades. An example of such beverages based primarily on coffee beverages are so-called Frappuccinos®. While such iced beverages are prepared with a pleasant appearance, they typically melt quickly when provided to the consumer and there is a consequent formation of a watery layer from the melted ice which is devoid of the flavouring present in the rest of the beverage. Furthermore, even when freshly prepared, the ice flakes are visible as agglomerates and are discernible to the consumer on drinking the beverage.

WO2014/135886 describes an apparatus for generating a slush containing frozen and non-frozen liquid. The slush is made from a draught beverage, such as beer, lager or cider.

FIG. 1 reproduces a diagrammatic view of the apparatus of WO2014/135886. The apparatus is in the form of a slush machine 18 and comprises a freeze conduit 3 for liquid 110, the conduit having an inlet 103 and an outlet 104 defining a volume 105 therebetween. A pump 2 feeds liquid through the volume 105 from the inlet 103 to the outlet 104 where it is then re-circulated back to the inlet 103 via conduit 1. Conduit 1 and freeze conduit 3 together define a conduit loop for recirculation of liquid. Slush can be dispensed from the loop from a dispensing outlet 8, the loop being replenished via a conduit loop inlet 7 from a reservoir 17.

An insulated slush recirculation umbilical 10 is added between the slush machine 18 and the dispensing outlet 8.

The freeze conduit 3 forms one half of a heat exchanger 6 with a cooling conduit 108 having an inlet 106 and an outlet 107 and containing a body of liquid glycol coolant 109 therebetween. Heat exchanger 6 is connected to a coolant loop that, as indicated by arrow A, circulates the liquid coolant from the inlet 106 to the outlet 107 to a coolant refrigeration unit 22 and then back to the inlet 106. The coolant is provided to the inlet of the cooling conduit at a temperature below the freeze point of the liquid; thus, when the coolant flows within the cooling conduit thermal heat transfer occurs from the liquid to the coolant. Coolant refrigeration unit 22 is a glycol chiller which includes a vapour compression refrigeration system 21 that is used to cool a reservoir of coolant 20. Pump 19 is integrated into the chiller unit and provides the motive force to re-circulate the coolant.

The rate of flow of liquid coolant through the cooling conduit 108 can be varied, thereby varying the rate of heat transfer out of the liquid in the volume 105 of the freeze conduit 3. By varying the flow rate of fresh coolant into the cooling conduit a net increase or decrease in the average temperature of the coolant within the cooling conduit is effected: this changes the overall thermal heat transfer rate from the working fluid to the coolant and hence the freeze rate in the working fluid flowing within the freeze conduit.

Flow through the cooling conduit is controlled by a valve 24. A lower rate of heat transfer is achieved by shutting off the coolant fluid flow rate to substantially zero so that there is no flow of coolant through the cooling conduit 108. A higher rate of heat transfer is achieved by opening valve 24 to allow flow of coolant through the cooling conduit 108.

An additional coolant bypass loop 111 is provided for diverting coolant flow away from the cooling conduit 108. Flow through this loop is controlled as required by a normally open valve 23.

Valves 23, 24 are controlled by a controller 15 in dependence on a sensor 4 to sense the fraction of frozen liquid in the generated slush. The sensor 4 is provided in the conduit loop 1 immediately upstream of the conduit inlet 103. The controller 15 can vary the heat transfer out of the liquid in volume 105 between different rates by controlling the flow of liquid coolant through the cooling conduit 108 in dependence on the output from the sensor 4. In an idle state, the machine is only required to overcome the base energy gains in the system to maintain the ice/liquid ratio of the working fluid in the re-circulated loop to the pre-set level desired. Thus, the lower rate of heat transfer is set by shutting the valve 24 to prevent flow of coolant through the cooling conduit 108. When dispense occurs, the volume of semi frozen working fluid dispensed is replaced with unfrozen working fluid from the reservoir 17. This results in a rapid reduction in the solid fraction of the fluid within the re-circulated loop that is sensed by the sensor 4, causing the control system to increase the rate of heat transfer out of the freeze conduit by opening valve 24 WO2018/122277 describes an apparatus and method for preparing an ice-containing tea or coffee beverage. The method comprises (i) providing a beverage liquor containing soluble tea or coffee solids, and a freezing-point suppressant; (ii) aerating the beverage liquor by the addition of a gas; (iii) flowing the aerated, preferably sweetened, beverage liquor through a refrigeration system to cool the aerated beverage liquor and to thereby form a plurality of ice crystals within the aerated beverage liquor; and (iv) dispensing the cooled aerated beverage liquor as an ice-containing tea or coffee beverage.

FIG. 2 reproduces a schematic of the apparatus of WO2018/122277. The apparatus 201 comprises a reservoir 205 for holding a beverage liquor. The reservoir 205 is connected via a supply duct 210 to a refrigeration circuit 215. The refrigerant circuit 215 comprises a plastic duct 216 within which the liquor flows, which has a recycle loop to permit the liquor to recirculate within the circuit 215. The refrigeration circuit 215 comprises a heat exchanger 220 for cooling the liquor using pre-chilled refrigerant which is flowed within a separate duct 225.

The refrigeration circuit 215 is also in fluid communication with a dispensing outlet 230 for dispensing an ice-containing tea or coffee beverage from the refrigeration circuit 215 into a receptacle 235.

A source of pressurised gas 240 is provided to supply pressurised gas into the supply duct 210 for aerating the beverage liquor. The gas may be supplied through a nozzle having a plurality of inlets to encourage the formation of fine bubbles. The gas mixing may also or alternatively involve a static mixer or one or more constricting orifices 241. A pump 245 is also provided to circulate the beverage within the refrigeration circuit 215.

The apparatus 201 allows the preparation of an ice-containing tea or coffee beverage. Beverage liquor containing soluble tea or coffee solids and a freezing point suppressant is pumped or driven with pressurised gas from the reservoir 205, through the supply duct 210 to the refrigeration circuit 215. Gas is dosed into the supply duct 210 from the gas source 240 via mixing means 241. The liquor circulates, driven by the pump 245, within the refrigeration circuit 215 and through the heat exchanger2 20, where it is cooled so that ice crystals form slowly. An ice-containing tea or coffee beverage is dispensed on demand from the circuit 215 via the outlet 230 into the beverage receptacle 235.

While the apparatus of WO2014/135886 is able to generate a slush containing frozen and non-frozen liquid and the apparatus of WO2018/122277 is able to prepare an ice-containing tea or coffee beverage, it would be desirable to improve the apparatus described.

### SUMMARY OF THE DISCLOSURE

According to a first aspect of the disclosure there is provided an apparatus for preparing an ice-containing tea or coffee beverage, the apparatus comprising:
a) a beverage concentrate reservoir containing a beverage concentrate;
b) a sweetener concentrate reservoir containing a sweetener concentrate;
c) a water pre-chiller containing or supplied with water;
d) a first pre-mixer for mixing the beverage concentrate supplied from the beverage concentrate reservoir with water supplied from the water pre-chiller;
e) a second pre-mixer for mixing the sweetener concentrate supplied from the sweetener concentrate reservoir with water supplied from the water pre-chiller;
f) a mixing chamber for mixing an output from the first pre-mixer with an output from the second pre-mixer to form a beverage liquor;
g) a cooling unit containing a coolant;
h) an ice-generating system;
i) a beverage product circuit for supplying the beverage liquor from the mixing chamber to the ice-generating system;
j) a cooling circuit for supplying coolant from the cooling unit to the ice-generating system to cool the beverage liquor and to thereby form a plurality of ice crystals within the beverage liquor; and
k) a beverage dispensing outlet for dispensing the ice-containing tea or coffee beverage from the ice-generating system into a receptacle.

The present disclosure will now be further described. In the following passages different aspects of the disclosure are defined in more detail. Each aspect so defined may be combined with any other aspect or aspects unless clearly indicated to the contrary. In particular, any feature indicated as being preferred or advantageous may be combined with any other feature or features indicated as being preferred or advantageous.

While the following description refers primarily to coffee beverages, it should be appreciated that the disclosure applies equally to tea beverages, i.e. to beverages comprising soluble tea and/or coffee solids.

The present apparatus and system relate to preparing an ice-containing tea or coffee beverage—a so-called iced tea or iced coffee beverage. Tea and coffee beverages are well-known and comprise dissolved tea and coffee solids. By way of example, a typical coffee beverage might be formed by reconstituting a spray- or freeze-dried coffee powder or by the extraction of roast and ground coffee beans. For the avoidance of doubt, a coffee beverage as defined herein is one produced from any part of the coffee plant, including elements from one or more of the coffee cherry, coffee husk, coffee beans, or coffee plant leaves. Similarly, a tea beverage is one produced from any part of a tea plant, typically an extraction from the leaves. The most preferred beverage is one made from coffee solids, such as are present in a standard coffee beverage, i.e. an espresso or cappuccino. Thus, the most preferred coffee solids are those obtained by extraction of a coffee bean.

According to the present apparatus and system, a beverage liquor is provided containing soluble tea or coffee solids which is cooled to thereby form a plurality of ice crystals within the beverage liquor. The beverage liquor may be formed by dilution of one or more concentrates, preferably liquid concentrates. For example, the beverage liquor may comprise a dilution of a beverage concentrate. A beverage liquor as defined herein refers to liquid used by or in the apparatus or method to form the beverage. Solids refer to those components of an aqueous solution which are left behind when all of the water is removed. Thus, for example, an instant soluble coffee powder may be considered the coffee solids of a dehydrated coffee extract. The solids are preferably soluble solids, but may contain small amounts of fine insoluble material.

The beverage liquor contains soluble coffee or tea solids. Preferably the liquor contains 0.5 to 6 wt %, by weight of the total beverage liquor of coffee or tea solids, more preferably from 1 to 5 wt % coffee or tea solids. This level of coffee or tea solids would typically provide a desirable strength of tea or coffee beverage.

The beverage liquor preferably also includes a freezing point suppressant in addition to the tea or coffee solids. As will be appreciated, a freezing point suppressant is an ingredient which reduces the temperature at which a liquid freezes. Generally any soluble ingredient will act to suppress the melting point of water, but the extent to which it affects the melting point will depend on the ingredient itself and the amount which is present.

The freezing point suppressant affects the ice-crystal growth. In a pure water/ice slush the ice is not particularly stable and is subject to a ripening process whereby small crystals tend to melt and larger crystals tend to grow. The presence of the freezing point suppressant serves to reduce this Ostwald ripening and allow the preservation of small ice crystals in the slush which is formed. The apparatus, method and system of the present disclosure favour the production of fine ice-crystals which are stabilised by the freezing point suppressant.

Preferably the beverage liquor comprises the freezing point suppressant in an amount sufficient to suppress the melting point of the beverage liquor by from 0.2 to 3° C. or more, preferably by from 0.4 to 1° C. This measurement is in comparison to the melting point of ice/water, and is based on the presence of the same concentration of the freezing point suppressant in a water solution. That is, this measurement disregards the presence of the tea and/or coffee solids which will also have a separate suppressing effect on the water. Melting point measurements are well known in the art. Preferably the melting point of the beverage liquor is suppressed to a temperature of −7° C. to −12° C. Beneficially, use of the freezing point suppressant may allow the end beverage as dispensed at a dispensing outlet into a receptacle to have a temperature of, for example, 0° C. to −1.5° C.

The freezing point suppressant may be any food-safe soluble ingredient such as a salt, an alcohol, a sugar, ice-structuring proteins or combinations of two or more thereof. It is most preferred that the freezing-point suppressant is a sweetener, such as a polyol or a sugar or a mixture thereof. The sweetener may be provided as a sweetener concentrate.

The most preferred freezing point suppressant is sugar, preferably sucrose and/or fructose. Suitable sugars include mono and disaccharides, preferably, sucrose, fructose, and/or glucose. A sugar replacement may be used in place of the sugar or a portion of the sugar. Suitable sugar replacements include polydextrose. If a sugar is included which has been separately refined from a coffee or tea material, then this is considered as part of the freezing point suppressant, rather than as part of the tea or coffee solids.

The use of conventional sugars permits the provision of a beverage made from simple, conventional beverage ingredients, such as coffee and sugar, and optionally milk, in a new form with a surprising physical appearance. Where the freezing point suppressant is sugar or another sweetener, the beverage liquor may be considered a sweetened beverage liquor.

Preferably the sweetened beverage liquor comprises 3.2 to 25 wt % sugar or sugar replacement, preferably 5 to 8 wt % sugar or sugar replacement. Preferably the sugar and/or sugar replacement is sucrose, fructose, polydextrose or a mixture thereof. In one example a mixture of 4 wt % fructose and 2.5 wt % polydextrose may be beneficially used. These amounts of sugar and/or sugar replacement are sufficient to depress the melting point, while also providing a desirable level of sweetness to the final beverage.

The beverage liquor may therefore comprise soluble coffee or tea solids and one or more sugars and/or sugar replacements, as well as the water forming the majority of the liquor. The beverage liquor may also include a dairy ingredient, such as milk or cream, preferably in an amount of less than 25 wt %, more preferably less than 10 wt %. The presence of such dairy ingredients in tea and coffee beverages is well known, such as for English breakfast tea, or for Lattes.

However, the presence of fat in the liquor, such as dairy fats from the inclusion of dairy ingredients affects the stability of the bubbles. In addition, the presence of high fat levels caused high viscosity increases during the cooling step, making the liquor difficult to pump and causing difficulty in providing a consistent ice fraction. Accordingly, the sweetened beverage liquor preferably comprises fats in an amount of less than 20 wt %, preferably less than 10 wt % and, preferably is substantially or completely free of fat.

The beverage liquor may further comprise other additives, such as flavourings, stabilisers, hydrocolloids (gums and thickeners), buffers, colouring agents, vitamins and/or minerals, and mouthfeel enhancers, or combinations of two or more thereof. These further additives preferably comprise less than 5 wt % of the beverage liquor, more preferably less than 1 wt % of the beverage liquor. Such additives as gums and thickeners are well-known to help stabilise thicker beverages such as iced coffees, but are considered by consumers to be unhealthy. Beneficially the beverage produced by the present apparatus and method can be very stable despite the absence of such ingredients.

Most preferably the beverage liquor is free from any such further additives and, therefore, the beverage liquor consists of only tea or coffee solids, a freezing point suppressant such as one or more sugars, and water, and optionally any dairy ingredient. Preferably the beverage liquor is free from any dairy ingredients.

Preferably, a level of dilution of the beverage concentrate in the first pre-mixer can be set independently of a level of dilution of the sweetener concentrate in the second pre-mixer. The apparatus may further comprise a controller configured and arranged to control a constitution of the beverage liquor by controlling the volumes and dilution ratios of the beverage concentrate and the sweetener concentrate supplied to the mixing chamber.

Preferably, the beverage concentrate reservoir and/or the sweetener concentrate reservoir comprises an exchangeable supply pack of concentrate. The exchangeable supply pack may comprise a container for holding the concentrate and a doser having an outlet for discharging beverage concentrate into the respective first pre-mixer or second pre-mixer. An exchangeable supply pack as defined herein refers to a pack that may be coupled with and decoupled from the apparatus as a means of supplying a volume of beverage concentrate for use by the apparatus. A full pack may be coupled to the apparatus. Coupling may comprise forming a mechanical connection between the pack and the apparatus. Once empty the pack may be decoupled from the apparatus and exchanged for another full pack which may then be coupled to the apparatus to supply further beverage concentrate for use by the apparatus. The pack may be a disposable item or alternatively may be re-fillable. The pack may comprise any suitable container including, but not limited to, a pouch, capsule, cartridge, box, bag-in-box or similar. The pack may be sealed prior to coupling with the apparatus. Means for opening the pack may be integrated in the pack or in the apparatus. The pack may be open automatically during coupling of the pack to the apparatus. A non-limiting example of a suitable pack for use as an exchangeable supply pack is the Promesso™ pack.

The first pre-mixer and/or the second pre-mixer may comprise a pre-mixer inlet for receiving concentrate from the outlet of the exchangeable supply pack, a pre-mixer outlet for discharging the output into the mixing chamber, and a conduit extending between the pre-mixer inlet and the pre-mixer outlet.

The first pre-mixer and/or the second pre-mixer may further comprise a water inlet opening into the conduit for feeding into the pre-mixer water supplied from the water pre-chiller. The water inlet opening may be orientated to jet inflowing water towards the pre-mixer inlet to thereby flush the outlet of the doser of the exchangeable supply pack.

The apparatus may further comprise a pre-chiller cooling circuit for supplying coolant from the cooling unit to the water pre-chiller to cool the water. The pre-chiller cooling circuit may comprise a heat exchanger that is cooled by the coolant, wherein the heat exchanger is, or is in thermal contact with, the water pre-chiller.

Preferably, the water pre-chiller and/or heat exchanger is additionally in thermal contact with the beverage concentrate reservoir containing the beverage concentrate.

The sweetener concentrate reservoir may be thermally isolated from the water pre-chiller and/or heat exchanger. Alternatively, the sweetener concentrate reservoir may be maintained in a chilled state. For example, the sweetener concentrate reservoir may be placed in thermal contact with the water pre-chiller and/or the heat exchanger and/or the beverage concentrate reservoir.

The mixing chamber may comprise an agitator for recirculating beverage liquor standing in the mixing chamber. Preferably, the mixing chamber is cooled.

The apparatus is preferably for preparing an aerated ice-containing tea or coffee beverage and may therefore further comprise an aerator. For example, the aerator may comprise a source of pressurised gas arranged to deliver pressurised gas into the beverage liquor before it is cooled.

The source of gas may be a gas cylinder containing air or nitrogen under pressure, or may be a compressor, pump or similar for on-demand supply of pressurised air. The gas may be supplied through one or more air inlets within the duct. In a preferred example the aerator is an air pump.

The gas is preferably added in an amount to achieve an overrun in the final beverage of from 10 to 150%, preferably from 20 to 100%, most preferably from 25 to 75%. Overrun is a standard term in the food and drinks industry to measure the amount of air included in a foamed foodstuff. The overrun may be calculated using the following formula:

$$Overrun = ( volume of foamed beverage - volume of initial liquid ) / volume of initial liquid * 100$$

Preferably the step of aerating the beverage liquor involves inline addition of the gas into a flow of the beverage liquor. That is, the gas is added into a duct containing a flow of the beverage liquor, rather than turbulent mixing of the liquor in a container, for example. The gas is preferably added before the beverage liquor is cooled to form the ice crystals.

In order to favour the production of a fine distribution of small bubbles, preferably the inline addition of gas is through a plurality of gas inlet orifices within the duct. Alternatively or in addition, the fine distribution of bubbles can be enhanced by passing the pumped flow of the beverage liquor with the added gas through a static mixer or one or more constricting orifices. The use of constricting orifices may be particularly advantageous because the high pressure jet which is then formed serves to split the bubbles into even finer bubbles which enhance the final beverage creaminess and stability.

By way of example, a 1 mm gas injection orifice might produce 5 mm bubbles in the duct. The passing of these bubbles through an orifice of less than 1 mm fractures these bubbles into bubbles smaller than 1 mm each. This fine bubble structure aids the ice stability and the creaminess of the final beverage.

The gas is preferably added at a pressure of up to 10 Bar, preferably from 3 to 4 Bar.

Forming a plurality of ice crystals within the beverage liquor produces an ice fraction within the beverage liquor. Preferably the ice fraction forms from 10 to 50 wt % of the beverage liquor, preferably from 20 to 30 wt %. This can be measured through the use of a simple cafetiere device used to decant the liquid from the ice-crystals and by determining the relative weights. In practice this may overstate the ice-fraction to a small extent, due to retained water, however, it provides consistently reproduceable and measurable results.

The ice-crystals produced in the method preferably have a size ranging from 0.1 to 1 mm, preferably 0.2 to 0.65 mm. Preferably the mean particle size is about 0.25 mm. The size may be measured on a sample using a microscope to measure the longest diameters of each ice crystal.

The cooling unit may comprise a liquid coolant. Preferably the liquid coolant comprises propylene glycol and is at a temperature of from −5° C. to −15° C. The cooling unit may be a glycol chiller. The coolant pump may integrated in the cooling unit or a separate pump located along the cooling circuit.

Preferably the apparatus is configured such that in a primary mode the coolant is continuously circulated around a primary cooling circuit comprising the cooling unit and/or in the secondary mode the coolant is continuously circulated around a secondary cooling circuit not including the cooling unit. In contrast, in the prior art system of WO2014/135886 coolant will remain stationary in the cooling conduit 108 when the lower rate of heat transfer is selected since the valve 24 is shut to prevent flow of coolant through the cooling conduit 108. The method of operation of WO2014/135886 may lead to deleterious effects, for example a new volume of cold coolant may be input into the cooling conduit 108 but not sufficient to fill the entire cooling conduit 108. This can lead to inconsistent cooling of the liquid 110 in the freeze conduit 3.

Preferably the apparatus may operate in one of the primary mode or the secondary mode when switched on. Beneficially this avoids, during operation of the apparatus, a situation where coolant is stationary within the cooling conduit for any substantial period of time. This may improve the homogeneity and consistency of the cooling of the beverage liquor.

The beverage product circuit may comprise one or more product supply conduits that fluidly connect the mixing chamber with the ice-generating system.

The ice-generating system may comprise a product conduit which receives the beverage liquor from the one or more product supply conduits and a cooling conduit. The ice-generating system may comprise at least a portion of the product conduit and the cooling conduit which may extend concentrically to one another. Preferably, the cooling conduit surrounds the product conduit. In one example the product conduit may comprise an inner tube that runs within an outer tube. The annular void external to the inner hose and within the outer tube defines the cooling conduit.

The concentrically extending product conduit and cooling conduit may be arranged into a spiral configuration. This may beneficially lead to a more compact arrangement of the ice-generating system and may also improve the homogeneity and consistency of the cooling of the beverage liquor. The concentrically extending product conduit and cooling conduit may extend for a length of at least 5 m, preferably at least 10 m.

Preferably the product conduit comprises a plastic duct within which the beverage liquor is pumped. Non-limiting examples of suitable materials include PTFE, Nylon, MDPE, EVA, Polyethylene, POM, PVC and mixtures thereof. The plastic surface of the duct reduces ice-crystal nucleation on the duct, encouraging the formation of ice crystals within the beverage liquor and reducing the risk of blockage. In prior art scraped refrigeration devices the ice-crystals tend to grow along the cooled surface walls and form plate-like shards. In contrast, the plastic piping encourages dendritic ice crystal growth from the walls into the flowing channel. Such crystals then get broken off quickly into the flow, where the flow and limited Ostwald ripening encourage more rounded development of the crystals: branches are snapped off or melt away. As a result, the ice crystals which form in the product conduit are smaller and tend to have a tighter, more rounded structure which adds to the longevity of the beverage produced.

The cooling conduit may also comprise a plastic duct. Non-limiting examples of suitable materials include PTFE, Nylon, MDPE, EVA, Polyethylene, POM, PVC and mixtures thereof.

The controller may comprise hardware and/or software. The controller may comprise a control unit or may be a computer program running on a dedicated or shared computing resource. The controller may comprise a single unit or may be composed of a plurality of sub-units within the apparatus that are operatively connected. The controller may be located on one processing resource or may be distributed across spatially separate computing resources. Separate portions of the apparatus, for example cooling unit, ice-generating system, mixer, etc. may comprise its own sub-controller that is operatively connected to the controller.

A product pump may be arranged to circulate the beverage liquor within the product conduit. This product pump may be configured to draw in the beverage liquor into the product conduit from an upstream location or this may require an additional pump or source of compressed gas. As will be appreciated, the apparatus will further comprise the necessary control valves to ensure that the flow is as intended.

In some examples the apparatus may further comprise a second beverage dispensing outlet for dispensing another tea or coffee beverage of a different type. The beverage of a different type may be a tea or coffee beverage not containing ice and may optionally be an aerated tea or coffee beverage not containing ice. Both the ice-containing tea or coffee beverage dispensed from the beverage dispensing outlet and the tea or coffee beverage of a different type dispensed from the second beverage dispensing outlet may be derived from the beverage liquor output from the mixing chamber.

The or each beverage dispensing outlet may take the form of a conventional beverage nozzle, such as a post-mix style head for ready provision of the final beverage at a bar or beverage counter.

The apparatus may form part of a beverage dispensing machine. The beverage dispensing machine may be a point-of-sale unit. The beverage dispensing machine may be a mobile unit. The beverage dispensing machine may be configured to be operated by a barkeeper or similar server or may be configured as a self-serve machine. The beverage dispensing machine may be a vending machine.

According to a further aspect there is provided a system comprising the apparatus according to the above aspect, a beverage concentrate reservoir and a sweetener concentrate reservoir.

Preferably, the beverage concentrate reservoir and the sweetener concentrate reservoir each comprise an exchangeable supply pack.

According to a further aspect there is provided an apparatus for preparing an ice-containing tea or coffee beverage, the apparatus comprising:
a) a sweetener concentrate reservoir containing a sweetener concentrate;
b) a water pre-chiller containing or supplied with water;
c) a first mixer for mixing the sweetener concentrate supplied from the sweetener concentrate reservoir with water supplied from the water pre-chiller to form a beverage liquor;
d) a cooling unit containing a coolant;
e) an ice-generating system;
f) a beverage product circuit for supplying the beverage liquor from the first mixer to the ice-generating system;
g) a cooling circuit for supplying coolant from the cooling unit to the ice-generating system to cool the beverage liquor and to thereby form a plurality of ice crystals within the beverage liquor;
h) a source of flavouring ingredient;
i) a second mixer for mixing flavouring ingredient from the source of flavouring ingredient with the beverage liquor from the ice-generating system to form an ice-containing beverage; and
j) a beverage dispensing outlet for dispensing the ice-containing beverage into a receptacle.

Beneficially, addition of flavouring ingredient to the beverage liquor after ice generation gives flexibility to change the flavour of the final beverage at or near the point of dispensing the beverage.

The flavouring ingredient may be, for example, a coffee concentrate, a tea concentrate, a fruit concentrate, milk, a milk concentrate, or a combination thereof.

The first mixer may, preferably be of the same type as the second pre-mixer described above in respect of other aspects of the present disclosure. The second mixer may, for example, a post mix style head located at or forming the dispensing outlet.

### BRIEF DESCRIPTION OF THE DRAWINGS

The disclosure will now be described, by way of example only, in relation to the following non-limiting figures, in which:

FIG. 1 shows a diagrammatic view of a prior art apparatus described in WO2014/135886;

FIG. 2 shows a schematic view of a prior art apparatus described in WO2018/122277;

FIG. 3 shows a perspective view of a beverage preparation machine according to the present disclosure;

FIG. 4 shows a flow schematic of a beverage preparation machine according to the present disclosure;

FIGS. 5A and 5B show comparative flow schematics for an ice-generating system of the prior art apparatus of WO2014/135886 and of an apparatus according to the present disclosure;

FIGS. 6A, 6B and 6C show schematic arrangements of portions of apparatus according to the present disclosure;

FIGS. 7A and 7B show alternative flow schematics for a product loop of the apparatus according to the present disclosure;

FIG. 8 shows a portion of an apparatus according to the present disclosure;

FIG. 9 shows a perspective view of another beverage preparation machine according to the present disclosure; and

FIG. 10 shows a flow schematic of the beverage preparation machine of FIG. 9.

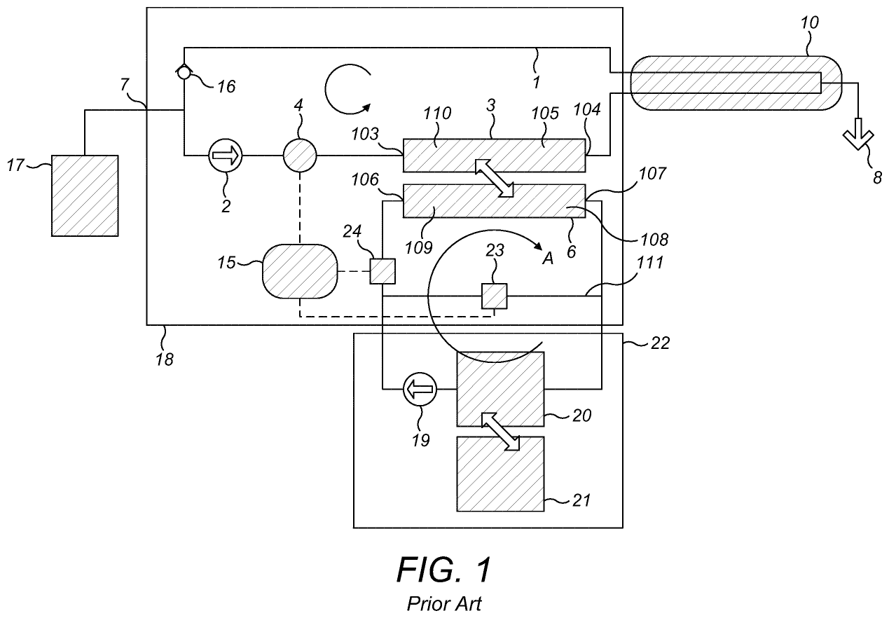

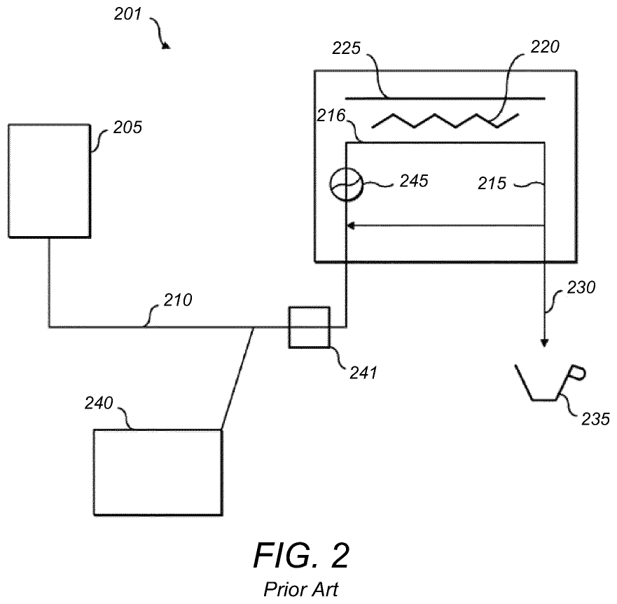

### DETAILED DESCRIPTION

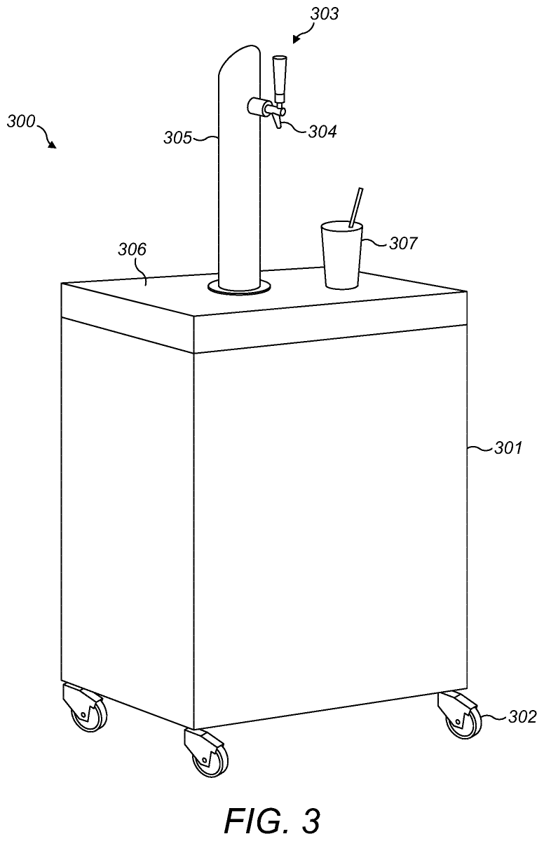

As shown in FIG. 3, the present disclosure provides an apparatus 300 for preparing an ice-containing tea or coffee beverage. In the illustrated example the apparatus 300 takes the form of a mobile point-of-sale unit which may be configured to be operated by a barkeeper or similar server or may be configured as a self-serve machine.

The apparatus 300 comprises a main housing 301 which may be configured, for example, as a cabinet that contains components of the apparatus 300. The main housing 301 may comprise one or more doors, drawers or access panels to allow access to the internal components for purposes of maintenance, restocking of ingredients, etc. The main housing 301 may be provided with castors 302 to render the apparatus 300 mobile. Connections for an external source of power, for example mains electricity, and an external source of water, for example mains water, may also be provided. Alternatively, the apparatus 300 may comprise an internal source of electrical power, for example a battery, and an internal source of water, such as a water reservoir.

The apparatus 300 may further comprise a beverage dispensing outlet 303 for dispensing a beverage. In the illustrated example, the beverage dispensing outlet 303 takes the form of a beverage nozzle 304, such as a post-mix style head, on a font 305 which is mounted to a top surface 306 of the main housing 301. The top surface 306 may serve as a stand or beverage counter for a receptacle, such as a glass 307, that receives the dispensed beverage.

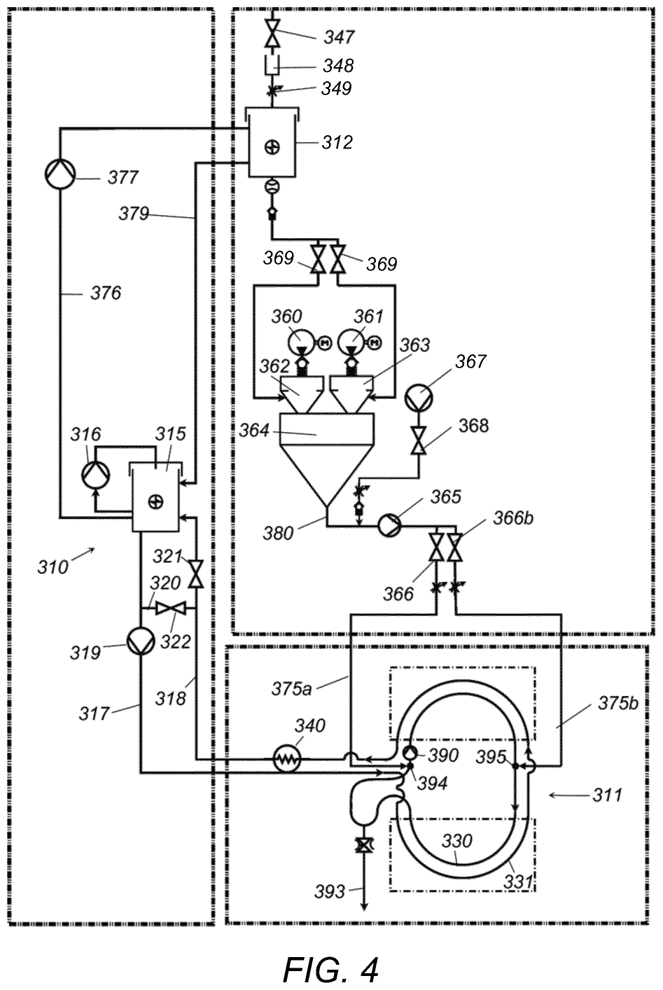

The apparatus 300 is configured for preparing an ice-containing tea or coffee beverage, preferably an aerated ice-containing tea or coffee beverage. FIG. 4 illustrates an example of a flow schematic for the apparatus 300 suitable to achieve this configuration. The apparatus 300 may comprise a cooling unit 310, an ice-generating system 311, a water pre-chiller 312 and an ingredient source section 313.

The cooling unit 310 comprises a coolant. The coolant may be a liquid coolant. Preferably the liquid coolant comprises propylene glycol and is held in a coolant reservoir within the cooling unit 310 at a temperature of from −5° C. to −15° C. The cooling unit 310 may comprise a compressor unit 316 for maintaining a desired temperature of the coolant in the coolant reservoir. The cooling unit 310 may be a glycol chiller 315.

As shown in FIG. 4, the cooling unit 310 may be connected to the ice-generating system 311 by one or more conduits to permit the supply and return of coolant to and from the ice-generating system 311. A plurality of configurations of conduits may be provided to permit the flow of coolant between the ice-generating system 311 and the cooling unit 310. Each configuration may be defined as a cooling circuit. Each configuration may be adopted by the actuation of one or more valves to control the conduits through which coolant will flow.

A coolant supply conduit 317 may be provided for supplying coolant from the cooling unit 310 to the ice-generating system 311. A coolant return conduit 318 may be provided for returning coolant from the ice-generating system 311 to the cooling unit 310.

A coolant pump 319 may be provided to pump the coolant between the ice-generating system 311 and the cooling unit 310. The coolant pump 319 may be integrated in the cooling unit 310 or be a separate pump located along the cooling circuit. Preferably, the coolant pump 319 is located in the coolant supply conduit 317.

A coolant bypass conduit 320 may be arranged to selectively direct coolant from the coolant return conduit 318 into the coolant supply conduit 317 without passing through the cooling unit 310. The coolant bypass conduit 320 may extend from a first junction 323 with the coolant return conduit 318 which is upstream of the cooling unit 310 to a second junction 324 with the coolant supply conduit 317 which is downstream of the cooling unit 310.

A cooling unit valve 321 may be provided for controlling flow from the coolant return conduit 318 into the cooling unit 310. The cooling unit valve 321 may be located in the coolant return conduit 318 downstream of the first junction 323. A coolant bypass conduit valve 322 may be provided for controlling flow through the coolant bypass conduit 320. The coolant bypass conduit valve 322 may be located in the coolant bypass conduit 320. In the illustrated example, each of the cooling unit valve 321 and the coolant bypass conduit valve 322 are a two-way valve, for example a solenoid valve.

Alternatively, the cooling unit valve 321 and the coolant bypass conduit valve 322 may be substituted for a three-way valve located at the first junction 323 which acts to divert flow of coolant through either the coolant return conduit 318 towards the cooling unit 310 or through the coolant bypass conduit 320 so as to bypass the cooling unit 310.

As shown in FIG. 4, the ice-generating system 311 comprises a product conduit 330 for containing a beverage liquor and a cooling conduit 331 which is arranged in proximity with the product conduit 330 to permit heat exchange between coolant in the cooling conduit 331 and beverage liquor in the product conduit 330. The ice-generating system 311 functions to form a plurality of ice crystals within the beverage liquor as explained further below.

The cooling conduit 331 may be fluidly connected to the coolant supply conduit 317 to receive coolant therefrom and also fluidly connected to the coolant return conduit 318 to deliver coolant thereto.

Preferably, at least a portion of the product conduit 330 and the cooling conduit 331 extend concentrically to one another. Preferably the cooling conduit 331 surrounds the product conduit 330. In one example, the product conduit 330 comprises an inner plastic tube that runs within an outer plastic tube. The annular void external to the inner plastic tube and within the outer plastic tube defines the cooling conduit 331.

The product conduit 330 and the cooling conduit 331 may be arranged into a spiral configuration. The product conduit 330 and the cooling conduit 331 may extend for a length of at least 5 m, preferably at least 10 m. The cooling conduit 331 may be split into two or more spiral loops, each loop extending concentrically with a different portion of the product conduit 330. For example, with a product conduit 330 of 10 m length in a spiral configuration the cooling conduit 331 may be split into two 5 m loops that run concentrically with, respectively, an upper half and a lower half of the product conduit 330. The coolant may be supplied to the loops of the cooling conduit 331 in parallel or series flow.

The conduits of the apparatus 300 may be configured into at least a primary cooling circuit and a secondary cooling circuit. The primary cooling circuit preferably comprises the cooling unit 310, the coolant supply conduit 317, the cooling conduit 331 and the coolant return conduit 318. The secondary cooling circuit preferably comprises the coolant supply conduit 317, the cooling conduit 331, the coolant return conduit 318 and the coolant bypass conduit 320 but does not comprise the cooling unit 310.

The apparatus 300 may further comprise a heater 340, for example a flow through heater, positioned in the primary cooling circuit and/or secondary cooling circuit. In the illustrated example the heater 340 is located in the coolant return conduit 318 so that it is located in a position that is common to both the primary cooling circuit and the secondary cooling circuit.

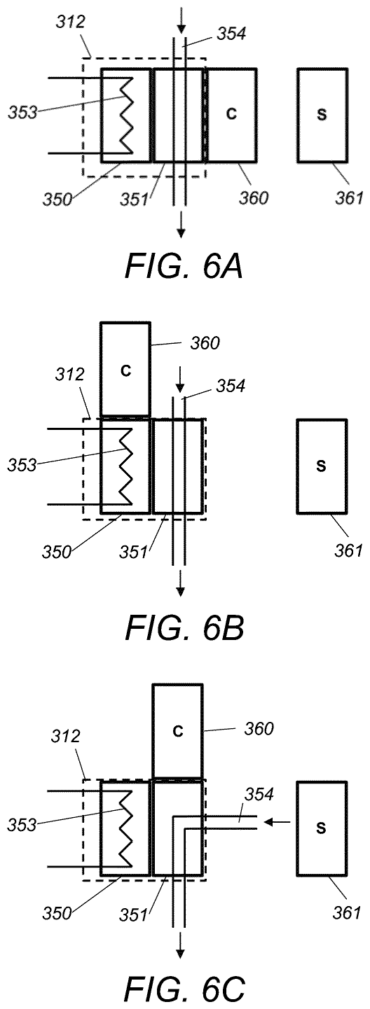

As shown in FIG. 4, the water pre-chiller 312 is provided for supplying chilled water to the ingredient source section 313. The water pre-chiller 312 may contain or be supplied with water. For example, the water pre-chiller 312 may contain a self-contained reservoir, such as a bottle or tank, containing a volume of water that is replenished from time to time by exchanging an empty reservoir for a full reservoir. However, preferably the water pre-chiller 312 is connected to receive water from an external source, such as mains water 347. A water filter 348 and flow control valve 349 may be provided to condition and control the supply. The water pre-chiller 312 may be any suitable device that can chill the incoming water down to a suitable temperature for supply to the ingredient source section 313. Preferably the water is chilled to a temperature of 2-5° C. The water pre-chiller 312 may be a phase change material (PCM) cooler or similar device. However, a preferred water pre-chiller 312 is illustrated schematically in FIGS. 6A to 6C and utilises flow of coolant from the cooling unit 310. In this example, the water in the water pre-chiller 312 is cooled by a heat exchanger that is itself cooled by coolant from the cooling unit 310. The heat exchanger may be either part of the water pre-chiller 312, or may be in thermal contact with the water pre-chiller 312. The heat exchanger may comprises one or more blocks for transferring thermal energy. In the example of FIG. 6A, a first block 350, preferably of aluminium, comprises a first conduit 353 through which coolant from the cooling unit 210 flows. Multiple first conduits may be provided. A second block 351, forming part of the water pre-chiller 312 and also preferably of aluminium, comprises a second conduit 354 through which the water in the water pre-chiller 312 flows. Multiple second conduits may be provided. Water in the second conduit 354 is cooled by heat transfer through the second block 351 and the first block 350. A single integral block may be provided instead of a first block 350 and a second block 352. The second conduit 354 may take a circuitous route through the second block 351 and/or water may be passed through the second conduit 354 multiple times to be chilled in successive passes. Further, the second conduit 354 may form a reservoir that holds stationary water for chilling as opposed to operating as a flow-through chiller.

As shown most clearly in FIG. 4, the cooling unit 310 may supply coolant to an ice-generating cooling circuit which supplies coolant from the cooling unit 310 to the ice-generating system 311 and a pre-chiller cooling circuit for supplying coolant from the cooling unit 310 to the water pre-chiller 312. Beneficially, a single cooling unit 310 can provide the coolant for both the ice-generating cooling circuit and the pre-chiller cooling circuit.

The pre-chiller cooling circuit may comprise a secondary coolant supply conduit 376 for supplying coolant from the cooling unit 310 to the water pre-chiller 312. A secondary coolant return conduit 379 may be provided for returning coolant from the water pre-chiller 312 to the cooling unit 310.

A secondary coolant pump 377 may be provided to pump the coolant between the cooling unit 310 and the water pre-chiller 312. The secondary coolant pump 377 may be integrated in the cooling unit 310 or be a separate pump located along the secondary cooling circuit. Preferably, the secondary coolant pump 377 is located in the secondary coolant supply conduit 376.

As shown in FIG. 4, the ingredient source section 313 comprises a beverage concentrate reservoir 360 containing a beverage concentrate. Preferably, it also comprises a sweetener concentrate reservoir 361 containing a sweetener concentrate. The beverage concentrate contains soluble coffee or tea solids. The sweetener concentrate contains a freezing point suppressant which may be a food-safe soluble ingredient such as a salt, an alcohol, a sugar and/or sugar replacement, ice-structuring proteins or combinations of two or more thereof. It is most preferred that the freezing-point suppressant is itself a sweetener, such as a polyol or a sugar or a mixture thereof. The most preferred freezing point suppressant is sugar or a sugar replacement, preferably sucrose and/or fructose and/or polydextrose. Suitable sugars include mono and disaccharides, preferably, sucrose, fructose, and/or glucose.

Optionally, the ingredient source section 313 may comprise two reservoirs containing, preferably, the same ingredient, wherein the apparatus is programmed to switch supply from a first of the two reservoirs to a second of the two reservoirs when the first of the two reservoirs is emptied. In this way a service-ready time of the apparatus may be increased. For example, the reservoir 360 and the reservoir 361 in the example of FIG. 4 may, optionally, be configured to both contain a same beverage concentrate-sweetener concentrate mix.

A first pre-mixer 362 may be provided for mixing the beverage concentrate supplied from the beverage concentrate reservoir 360 with water supplied from the water pre-chiller 312. Likewise, a second pre-mixer 363 may be provided for mixing the sweetener concentrate supplied from the sweetener concentrate reservoir 361 with water supplied from the water pre-chiller 312. The water supply to the first pre-mixer 362 and/or the second pre-mixer 363 may be controlled by supply valves 369.

The ingredient source section 313 may further comprise a mixing chamber 364 for mixing an output from the first pre-mixer 362 with an output from the second pre-mixer 363 (where present) to form a beverage liquor. Water may be supplied to the mixing chamber 364 from the water pre-chiller 312 in addition to, or in place of, supplying water to the first pre-mixer 362 and the second pre-mixer 363. The mixing chamber 364 may comprise an agitator for assisting in the mixing of the beverage liquor and also for recirculating beverage liquor standing in the mixing chamber 364. The agitator may comprise a rotating blade, paddle, whisk or similar device. Additionally or alternatively, the agitator may comprise a recirculation of the beverage liquor from an output of the mixing chamber 364 back into the mixing chamber 364 to create turbulence and mixing of the beverage liquor within the mixing chamber 364. A recirculation pump and recirculation conduit may be provided to affect such agitation.

The beverage liquor may then be supplied onwards to the ice-generating system 311 as explained further below.

The beverage concentrate in the beverage concentrate reservoir 360 may be a powder but is preferably a liquid concentrate. Likewise, the sweetener concentrate in the sweetener concentrate reservoir 361 may be a powder but is preferably a liquid concentrate.

The beverage concentrate reservoir 360 and the sweetener concentrate reservoir 361 may each comprise a chamber, hopper or similar that is manually filled with concentrate by an operator, for example by opening a bulk container of concentrate and pouring the concentrate into the chamber or hopper. However, it is preferred that the beverage concentrate reservoir 360 and the sweetener concentrate reservoir 361 each comprise an exchangeable supply pack which may be coupled with and decoupled from the apparatus 300. The use of exchangeable supply packs may improve the ease and cleanliness of use of the apparatus 300. Various types of exchangeable supply pack may be used including, but not limited to, a pouch, capsule, cartridge, box, bag-in-box or similar. The exchangeable supply pack may be sealed prior to coupling with the apparatus 300. Means for opening the exchangeable supply pack may be integrated in the exchangeable supply pack or in the apparatus 300. The exchangeable supply pack may be opened automatically during coupling of the exchangeable supply pack to the apparatus 300. A preferred option for the exchangeable supply pack is a Promesso® exchangeable supply pack available from Koninklijke Douwe Egberts B.V. Such an exchangeable supply pack may include a container for holding the concentrate and a doser having an outlet. The doser is arranged for supplying the concentrate from the container to the outlet of the doser in a dosed manner. The doser may include a pump assembly that enables the pumping of a desired dosage of the concentrate from the container out of the outlet and into the pre-mixer 362, 363.

The exchangeable supply pack and the apparatus may be mechanically connectable. When connected, the outlet of the doser is brought in fluid communication with the respective pre-mixer 362, 363 and a drive shaft (not shown) of the apparatus 300 may be arranged for transmitting torque from the apparatus 300 to the doser such that when the drive shaft is activated concentrate is supplied from the outlet of the doser into the pre-mixer 362, 363.

As shown in FIG. 8, each pre-mixer 362, 363 may be provided with a pre-mixer inlet 370 for receiving concentrate from the doser of the exchangeable supply pack. The pre-mixer inlet 370 may be located towards a top of the pre-mixer 362, 363 such that the concentrate may flow from the outlet of the doser into the pre-mixer 362, 363 substantially under the influence of gravity.

A pre-mixer outlet 372 may be provided for discharging the output into the mixing chamber 364 and a conduit 371 may extend between the pre-mixer inlet 370 and the pre-mixer outlet 372. Further, each pre-mixer 362, 363 may comprise a water inlet opening 373 into the conduit 371 for feeding into the pre-mixer 362, 363 water supplied from the water pre-chiller 312. Preferably, the water inlet opening 373 is orientated to jet inflowing water towards the pre-mixer inlet 370 to thereby flush the outlet of the doser of the exchangeable supply pack, which in use is coupled to the pre-mixer inlet 370.

It is preferred to maintain the beverage concentrate in a chilled state to maintain freshness and improve shelf-life. In order to achieve this, it is preferred that the water pre-chiller 312 and/or the heat exchanger is in thermal contact with the beverage concentrate reservoir 360. The water pre-chiller 312 and/or the heat exchanger may also beneficially be in thermal contact with the pre-mixer 362 and/or mixing chamber 364.

In one example, the beverage concentrate reservoir 360 is in contact with the first block 350 and/or the second block 351. Optionally the first block 350 and/or the second block 351 are in face-to-face contact with a face of the beverage concentrate reservoir 360. The use of exchangeable supply packs that are parallelepiped in shape may be beneficial for this as they provide a relatively large surface area to make contact with the first block 350 and/or the second block 351. In the arrangement of FIG. 6A, a beverage concentrate reservoir 360 in the form of an exchangeable supply pack C is positioned alongside, and in thermal contact with, the water pre-chiller 312, in particular the second block 351 thereof. A side face of the exchangeable supply pack C is preferably in face-to-face contact with a side face of the second block 351. In the alternative arrangement of FIG. 6B, the exchangeable supply pack C is positioned above, and in thermal contact with, the water pre-chiller 312, in particular the first block 350 thereof. A bottom face of the exchangeable supply pack C is preferably in face-to-face contact with a top face of the first block 350. In the further alternative arrangement of FIG. 6C, the exchangeable supply pack C is positioned above, and in thermal contact with, the water pre-chiller 312, in particular the second block 351 thereof. A bottom face of the exchangeable supply pack C is preferably in face-to-face contact with a top face of the second block 351.

Preferably, the sweetener concentrate reservoir 361 is thermally isolated from the water pre-chiller 312 and/or heat exchanger. This may be beneficial to prevent crystallisation of the ingredients of the sweetener concentrate. Preferably the temperature of the sweetener concentrate reservoir 361 is maintained at greater than 10° C. For example, in the arrangements of FIG. 6A to 6C, the sweetener concentrate reservoir 361 in the form of an exchangeable supply pack S is separated from, i.e. out of thermal contact with, the water pre-chiller 312. Optionally, thermal insulation material may be interposed between the sweetener concentrate reservoir 361 and the water pre-chiller 312.

An output 380 of the mixing chamber 364 may supply the beverage liquor to the ice-generating system 311 via a beverage product circuit which may comprise one or more conduits and one or more product supply valves 366a, 366b. The beverage liquor is preferably aerated prior to reaching the ice-generating system 311. An air pump 367 may inject air under control of an air supply valve 368 into the conduit containing the beverage liquor before it reaches the one of more product supply valves 366a, 366b. The air may be injected through one or more gas injection orifices. In order to favour the production of a fine distribution of small bubbles the flow of the beverage liquor with the added gas may be pumped through a static mixer or one or more constricting orifices. By way of example, a 1 mm gas injection orifice might produce 5 mm bubbles in the conduit. The passing of these bubbles through an orifice of less than 1 mm fractures these bubbles into bubbles smaller than 1 mm each. This fine bubble structure aids the ice stability and the creaminess of the final beverage. The air is preferably added at a pressure of up to 10 Bar, preferably from 3 to 4 Bar. The beverage liquor may be pumped out of the mixing chamber 364 and through the product supply valves 366a, 366b by means of an upstream product pump 365 as shown in FIG. 4.

The one or more product supply valves 366a, 366b may connect to the product conduit 330 of the ice-generating system 311. The one or more product supply valves 366a, 366b may comprise a first product supply valve 366a and a second product supply valve 366b. The product conduit 330 may form a loop to allow the beverage liquor to circulate. Beverage liquor may be input into the product conduit 330 through one or more beverage liquor inlets. A first beverage liquor inlet 394 may be provided which may be connected to the first product supply valve 366a by a first product supply conduit 375a of the beverage product circuit. A second beverage liquor inlet 395 may be provided which may be connected to the second product supply valve 366b by a second product supply conduit 375b of the beverage product circuit.

Beverage liquor containing the plurality of ice crystals may be discharged from the product conduit 330 through an outlet 393 that supplies the beverage dispensing outlet 303. Preferably, only a single outlet 393 is provided. Preferably, the volume and/or pressure of the beverage liquor within the product conduit 330 is maintained within set limits, and preferably substantially constant and preferably at around 2 bar. This may be achieved by ensuring that the total volume of beverage liquor input to the product conduit 330 through the one or more beverage liquor inlets 394, 395 equals the volume of the beverage liquor discharged through the outlet 393.

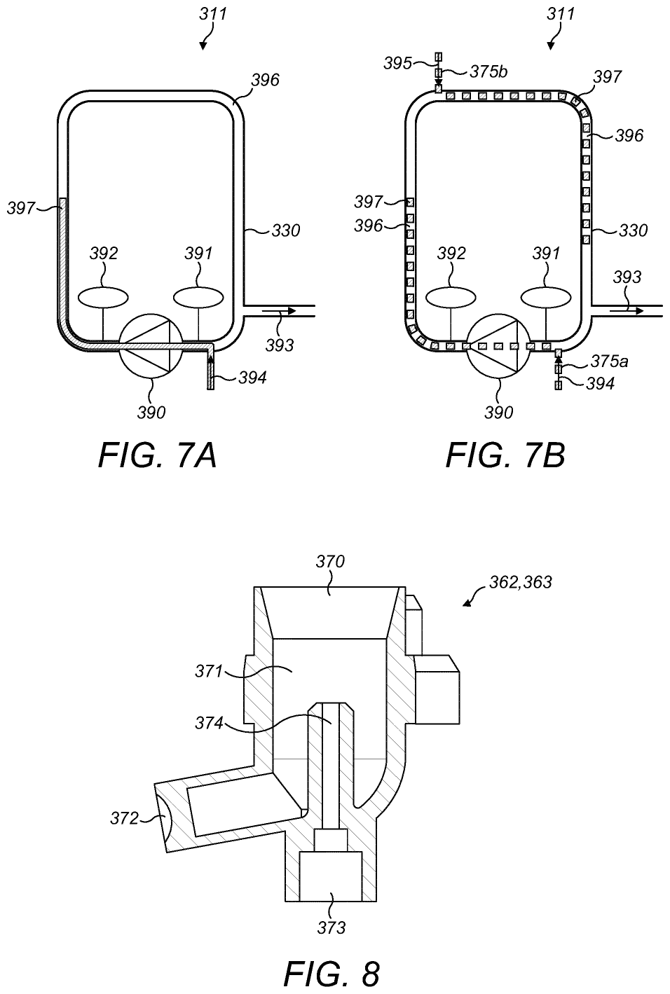

The product conduit 330 comprises a primary product pump 390 for circulating the beverage liquor around the product conduit 330. An upstream pressure sensor 391 and a downstream pressure sensor 392, as shown in FIGS. 7A and 7B, may be located on either side of the primary product pump 390 to sense the differential pressure across the primary product pump 390. This differential pressure may be used to calculate, infer or estimate the ice/liquid ratio of the beverage liquor.

FIG. 7A illustrates an example where only a first beverage liquor inlet 394 is provided. A quantity of relatively warm beverage liquor 397 is input through first beverage liquor inlet 394 and is circulated clockwise (as viewed in FIG. 7A) at the same time as already present and relatively cold beverage liquor 396 containing a plurality of ice crystals is discharged through the outlet 393. As the relatively warm beverage liquor 397 passes the primary product pump 390 a change in the differential pressure between the upstream pressure sensor 391 and the downstream pressure sensor 392 is detected by the controller which acts to increase the rate of cooling of the product conduit 330, as discussed further below, to cool the relatively warm beverage liquor 397 to form the desired ice/water ratio.

A potential disadvantage of the arrangement of FIG. 7A is that frozen blockages may occur where the increased rate of cooling commanded by the controller imparts further cooling to the relatively cold beverage liquor 396 still circulating in the product conduit 330.

Thus, FIG. 7B presents an improved arrangement wherein at least the first beverage liquor inlet 394 and the second beverage liquor inlet 395 are used. The first beverage liquor inlet 394 and the second beverage liquor inlet 395 are distributed along the product conduit 330. For example, the loop of the product conduit 330 may be considered to have a length of X, and the second beverage liquor inlet 395 may be located between 0.4X and 0.6X along the loop of the product conduit 330 from the first beverage liquor inlet 394. For example, in the case of a product conduit 330 of length X=10 m the second beverage liquor inlet 395 would be located between 4 m (10 m×0.4) and 6 m (10 m×0.6) along the loop of the product conduit 330 from the first beverage liquor inlet 394. More preferably, the second beverage liquor inlet 395 may be located halfway around the loop of the product conduit 330 from the first beverage liquor inlet 394, i.e. at 0.5X. Optionally, third and/or fourth, etc. beverage liquor inlets may be provided. These may preferably be evenly distributed around the loop of the product conduit 330, i.e. at 0X, 0.33X and 0.67X where three beverage liquor inlets are provided; at 0X, 0.25X. 0.50X and 0.75X where four beverage liquor inlets are provided, etc.

Inputting the relatively warm beverage liquor 397 through at least two beverage liquor inlets is beneficial as it provides a more even distribution of the relatively warm beverage liquor 397 in the relatively cold beverage liquor 396 as shown schematically in FIG. 7B. This may help or reduce or eliminate frozen blockages occurring. Further benefit can be achieved by configuring and arranging for the input of beverage liquor into the product conduit 330 to be alternated, preferably relatively quickly, between the at least two beverage liquor inlets such that ‘chunks’ of relatively warm beverage liquor 397 are input into the flow of relatively cold beverage liquor 396 such that each chunk is bounded on either side by relatively cold beverage liquor 396. This may beneficially create an even more even distribution of the relatively warm beverage liquor 397 in the relatively cold beverage liquor 396. This may reduce or eliminate frozen blockages occurring. In addition, using this arrangement may mean that the controller does not need to switch rapidly from an aggressive cooling mode to a non-cooling mode. Further the proximity of the relatively cold beverage liquor 396 to the relatively small volume of each chunk of relatively warm beverage liquor 397 helps to cool more efficiently the relatively warm beverage liquor 397.

This configuration may be achieved by arranging the first product supply valve 366a for controlling flow of beverage liquor to the first beverage liquor inlet 394 and the second product supply valve 366b for controlling flow of beverage liquor to the second beverage liquor inlet 395 as noted above. Further, the controller may be configured and arranged to control actuation of the first product supply valve 366a and the second product supply valve 366b to alternate the input of beverage liquor into the product conduit 330 through the first product supply valve 366a and the second product supply valve 366b by cycling the first product supply valve 366a and the second product supply valve 366b between a first configuration where the first product supply valve 366a is open and the second product supply valve 366b is closed and a second configuration where the first product supply valve 366a is closed and the second product supply valve 366b is open. Preferably the cycle time may be such as to obtain a valve open time of 0.3 to 0.8 seconds, preferably 0.4 to 0.6 seconds, more preferably 0.5 seconds for each cycle. Preferably, the cycling of the first product supply valve 366a and the second product supply valve 366b includes an overlap period in each cycle where both the first product supply valve 366a and the second product supply valve 366b are open to help ensure a constant inflow into the product conduit 330.

A non-limiting example of use of the apparatus 300 will now be described. A beverage concentrate reservoir 360 in the form of a Promesso™ exchangeable supply pack containing a beverage concentrate containing soluble coffee solids and a sweetener concentrate reservoir 361 in the form of a Promesso™ exchangeable supply pack containing a sweetener concentrate are installed in the apparatus 300, mechanically coupled to the respective first pre-mixer 362 and second pre-mixer 363.

Water supplied to the water pre-chiller 312 is chilled to a temperature of 2-5° C. by coolant flowing through the pre-chiller cooling circuit, in particular wherein coolant is pumped by the secondary coolant pump 377 from the cooling unit 310 along the secondary coolant supply conduit 376, through the first conduit 353 of the heat exchanger and then back to the cooling unit 310 along secondary coolant return conduit 379. Flow of the coolant around the pre-chiller cooling circuit is controlled by the controller. As will be appreciated by those skilled in the art, sensors and/or meters, for example flow meters and temperature sensors, may be provided to provide the necessary data inputs to the controller to permit flow and/or temperature control of the pre-chiller cooling circuit to be achieved.

When demanded by the controller, a dose of beverage concentrate is dosed from the beverage concentrate reservoir 360 into the first pre-mixer 362 through the pre-mixer inlet 370 where it is mixed and diluted with water that is injected through the water inlet opening 373. This water is supplied from the water pre-chiller 312 by the controller opening the respective supply valve 369. The diluted beverage concentrate passes along the conduit 371 and is discharged through the pre-mixer outlet 372 into the mixing chamber 364.

If required by the beverage being dispensed, a dose of sweetener concentrate may also be dosed, preferably simultaneously, from the sweetener concentrate reservoir 361 into the second pre-mixer 363 through the pre-mixer inlet 370 where it is mixed and diluted with water that is injected through the water inlet opening 373. As above, this water is supplied from the water pre-chiller 312 by the controller opening the respective supply valve 369. The diluted sweetener concentrate passes along the conduit 371 and is discharged through the pre-mixer outlet 372 into the mixing chamber 364.

The diluted beverage and sweetener concentrates are mixed together in the mixing chamber 364 by the agitator to form the beverage liquor.

When demanded by the controller, beverage liquor from the mixing chamber 364 is supplied to the ice-generating system 311 through the first product supply conduit 375a and the second product supply conduit 375b by operation of the first product supply valve 366a and the second product supply valve 366b. The beverage liquor is aerated prior to reaching the ice-generating system 311. The air pump 367 injects air under control of the air supply valve 368 into the conduit containing the beverage liquor before it reaches the first product supply valve 366a and the second product supply valve 366b.

As illustrated schematically in FIG. 7B, the controller controls actuation of the first product supply valve 366a and the second product supply valve 366b to alternate the input of beverage liquor into the product conduit 330 through the first product supply valve 366a and the second product supply valve 366b by cycling the first product supply valve 366a and the second product supply valve 366b between the first configuration and the second configuration with a cycle time of 0.3 to 0.8 seconds, preferably 0.4 to 0.6 seconds, more preferably 0.5 seconds for each cycle. Preferably, the cycling of the first product supply valve 366a and the second product supply valve 366b includes an overlap period in each cycle where both the first product supply valve 366a and the second product supply valve 366b are open to help ensure a constant inflow into the product conduit 330. Consequently, the beverage liquor is input into the product conduit 330 from at least two locations as ‘chunks’ of relatively warm beverage liquor 397 such that each chunk is bounded on either side by relatively cold beverage liquor 396.

The relatively warm beverage liquor 397 circulates in the product conduit 330 where it is cooled by the coolant flowing in the cooling conduit 331 and preferably also by the already present relatively cold beverage liquor 396 to form a plurality of ice crystals in the aerated beverage liquor.

Simultaneously, aerated beverage liquor that already contains a plurality of ice crystals is discharged out of the product conduit 330 through the single outlet 393 onwards to the beverage dispensing outlet 303 where it is dispensed into the glass 307.

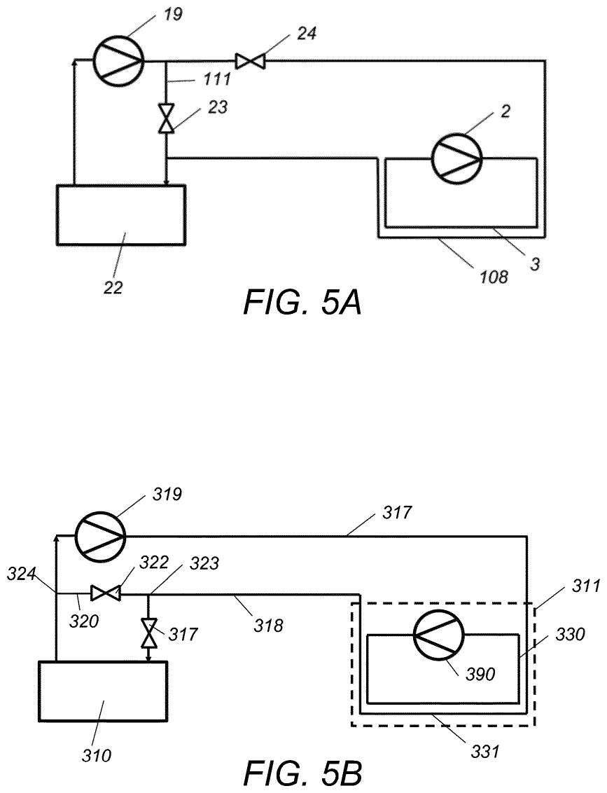

As shown in FIG. 5B, the coolant flowing in the cooling conduit 331 may be in a direction that opposes the flow of beverage liquor in the product conduit 330.

When active cooling of the beverage liquor in the product conduit 330 is required—for example, because the ice/water ratio as sensed by the upstream pressure sensor 391 and downstream pressure sensor 392 is not at a desired level—the controller switches the ice-generating system 311 to the primary mode wherein the coolant is circulated around the cooling unit 310, the coolant supply conduit 317, the cooling conduit 331 and the coolant return conduit 318. By passing the coolant through the cooling unit 310 in the primary mode the coolant is cooled and so active cooling of the beverage liquor is achieved. Beneficially, in the primary mode coolant may flow continuously around the primary cooling circuit and is not required to become stationary.

When active cooling of the beverage liquor in the product conduit 330 is not required—for example, because the ice/water ratio as sensed by the upstream pressure sensor 391 and downstream pressure sensor 392 is at the desired level—the controller switches the ice-generating system 311 to the secondary mode wherein the coolant is circulated around the secondary cooling circuit comprising the coolant supply conduit 317, the cooling conduit 331, the coolant return conduit 318 and the coolant bypass conduit 320. In particular, the secondary cooling circuit does not comprise the cooling unit 310 so the coolant is not subjected to any additional cooling. This allows the coolant to gradually warm up as it circulates around the secondary cooling loop. Beneficially, in the secondary mode coolant may flow continuously around the secondary cooling circuit and is not required to become stationary.

This method is in contrast to the prior art arrangement of WO2014/135886, shown schematically in FIG. 5B. In that arrangement, when active cooling of the beverage liquor in the cooling conduit 108 is not required the valve 24 is shut to prevent flow of coolant through cooling conduit 108. Valve 23 is opened to circulate the coolant via the coolant bypass loop and through the coolant refrigeration unit 22 using pump 19. However, coolant in the cooling conduit 108 remains stationary.

Thus, the present apparatus 300, system and method permit the preparation of an ice-containing tea or coffee beverage, which is also preferably aerated. The appearance of the beverage which is produced will depend on the ice-fraction and the overrun of the beverage. A beverage with a high overrun, such as 100% and a low ice-fraction, such as 10 to 20%, may resemble a homogeneous light brown foam and may retain this form and stability for upward of 10 minutes. In practice the ice is well insulated and melts slowly. Eventually an underlying coffee or tea layer may form, but this may typically take at least 30 minutes. Preferably no separate water layer forms, as would be seen in a beverage made from coarse ice-crystals. In a beverage with coarser ice-crystals, these typically migrate to the top as they are least dense and then melt without the beverage solids being present.

A beverage with a lower overrun, such as 25% and with a higher ice fraction, such as 30%, may form an initial thicker foam layer on a darker beverage layer. However, the whole structure will have an even distribution of ice and will not form a separate water layer. Instead it may resemble, albeit with less separation, the classic beverage Guinness® appearance of a dark liquor with a foamed head and demonstrates a storm-cloud settling effect. The foam persists in part because it is stabilised by the fine ice-crystals distributed therein.

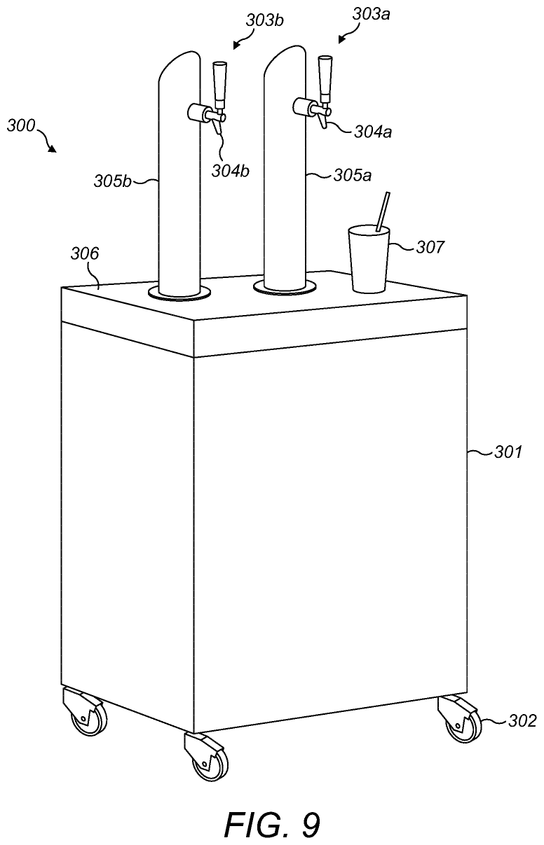

FIG. 9 illustrates a further embodiment of apparatus 300 according to the present disclosure. In the following description only the differences between this embodiment and the preceding embodiments will be described. It will be understood by the skilled reader that in all other respects the apparatus 300 may be configured and function as described above in the preceding embodiments.

As in the previous embodiments the apparatus 300 of FIG. 9 may take the form of a mobile point-of-sale unit which may be configured to be operated by a barkeeper or similar server or may be configured as a self-serve machine. The apparatus 300 may comprise a first beverage dispensing outlet 303a for dispensing a first beverage and a second dispensing outlet 303b for dispensing a second beverage. In the illustrated example, the beverage dispensing outlets 303a, 303b each take the form of a beverage nozzle 304a, 304b, such as a post-mix style head. The beverage dispensing outlets 303a, 303b may both be provided for example on a single font or, as illustrated in FIG. 9, separately on two fonts 305a, 305b each of which is mounted to the top surface 306 of the main housing 301.

The apparatus 300 may be configured for preparing an ice-containing tea or coffee beverage, preferably an aerated ice-containing tea or coffee beverage, which may be dispensed via the first beverage dispensing outlet 303a. The apparatus 300 may in addition be configured for preparing another beverage of a different type which may be dispensed via the second beverage dispensing outlet 303b. The beverage of the different type may be for example a beverage not containing ice, for example a tea or coffee beverage not containing ice. The beverage of the different type may for example be an aerated tea or coffee beverage and preferably a cooled and aerated tea or coffee beverage.

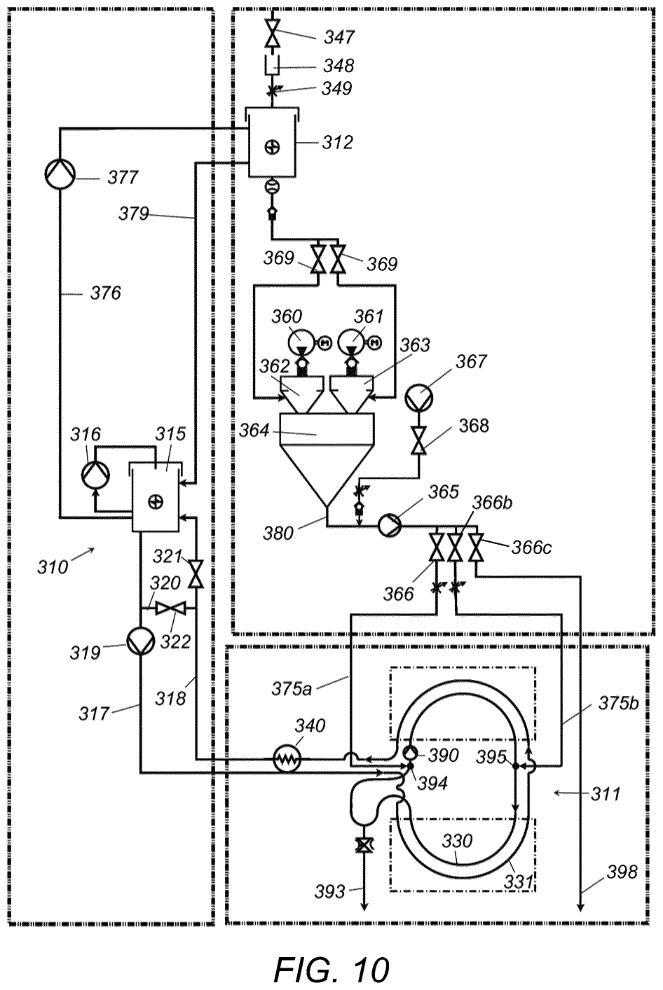

FIG. 10 illustrates an example of a flow schematic for the apparatus 300 suitable to achieve this configuration. The flow schematic is the same as that of FIG. 4 except for the following points.

The beverage supplied to the second beverage dispensing outlet 303b by-passes the ice-generating system 311 such that ice crystals are not formed in the beverage prior to dispensation. Instead the beverage may consist of or comprise the beverage liquor that is output from the mixing chamber 364. As shown in FIG. 10, an additional product supply valve 366c may be provided to selectively direct the beverage liquor to the second dispensing outlet 303b via a beverage conduit 398. As in the above embodiments, this beverage liquor may optionally be aerated by the air pump 367. The upstream product pump 365 may drive the flow of beverage liquor to the second beverage dispensing outlet 303b.

In operation of the apparatus 300 an ice-containing beverage may be dispensed from the first beverage dispensing outlet 303a and a non-ice-containing beverage may be dispensed from the second beverage dispensing outlet 303b. Advantageously, the same beverage liquor output from the mixing chamber 364 may be used to supply both beverage dispensing outlets 303a, 303b.

The apparatus 300 may additionally or alternatively be adapted compared to the preceding embodiments by maintaining the sweetener concentrate reservoir 361 in a chilled state within the apparatus 300. It has been found that chilling of the sweetener concentrate reservoir 361 is not always required to prevent ice crystallisation, in particular in situations where the expected usage rate of the sweetener concentrate means that the sweetener concentrate reservoir 361 will be replaced every 5 to 10 days. Advantageously chilling the sweetener concentrate reservoir 361 can provide improved efficiency when cooling the resulting beverage liquor containing the sweetener concentrate, reduce the risk of microbial growth and reduce the length of conduits required to connect the sweetener concentrate reservoir 361 to a remainder of the apparatus 300. Further, maintaining both the beverage concentrate reservoir 360 and the sweetener concentrate reservoir 361 in a chilled state may allow a simplified component layout within the housing 301. For example, a separate uncooled chamber is not required for the sweetener concentrate reservoir 361 and both reservoirs 360, 361 can be stored in the same compartment.

In a first example configuration the sweetener concentrate reservoir 361 may be placed in thermal contact with the water pre-chiller 312 and/or the heat exchanger and/or the beverage concentrate reservoir 360. For example, the sweetener concentrate reservoir 361 in the form of the exchangeable supply pack S may be positioned alongside, and in thermal contact with, the water pre-chiller 312, in particular the first block 350 and/or second block 351 thereof.

In a second example configuration the beverage concentrate reservoir 360 and the sweetener concentrate reservoir 361 may be placed in a refrigerated compartment of the apparatus. The refrigerated compartment may be cooled by the water pre-chiller 312 and/or the heat exchanger and/or by another refrigeration means.

Although preferred embodiments of the present disclosure have been described herein in detail, it will be understood by those skilled in the art that variations may be made thereto without departing from the scope of the appended claims.

1: Apparatus for preparing an ice-containing tea or coffee beverage, the apparatus comprising:
a) a beverage concentrate reservoir containing a beverage concentrate;
b) a sweetener concentrate reservoir containing a sweetener concentrate;
c) a water pre-chiller containing or supplied with water;
d) a first pre-mixer for mixing the beverage concentrate supplied from the beverage concentrate reservoir with water supplied from the water pre-chiller;
e) a second pre-mixer for mixing the sweetener concentrate supplied from the sweetener concentrate reservoir with water supplied from the water pre-chiller;
f) a mixing chamber for mixing an output from the first pre-mixer with an output from the second pre-mixer to form a beverage liquor;
g) a cooling unit containing a coolant;
h) an ice-generating system;
i) a beverage product circuit for supplying the beverage liquor from the mixing chamber to the ice-generating system;
j) a cooling circuit for supplying coolant from the cooling unit to the ice-generating system to cool the beverage liquor and to thereby form a plurality of ice crystals within the beverage liquor; and
k) a beverage dispensing outlet for dispensing the ice-containing tea or coffee beverage from the ice-generating system into a receptacle.

2: Apparatus as claimed in claim 1, wherein a level of dilution of the beverage concentrate in the first pre-mixer can be set independently of a level of dilution of the sweetener concentrate in the second pre-mixer.

3: Apparatus as claimed in claim 1, further comprising a controller configured and arranged to control a constitution of the beverage liquor by controlling the volumes and dilution ratios of the beverage concentrate and the sweetener concentrate supplied to the mixing chamber.

4: Apparatus as claimed in claim 1, wherein the beverage concentrate reservoir and/or the sweetener concentrate reservoir comprises an exchangeable supply pack of concentrate.

5: Apparatus as claimed in claim 4, wherein the exchangeable supply pack comprises a container for holding the concentrate and a doser having an outlet for discharging beverage concentrate into the respective first pre-mixer or second pre-mixer.

6: Apparatus as claimed in claim 5, wherein the first pre-mixer and/or the second pre-mixer comprises a pre-mixer inlet for receiving concentrate from the outlet of the exchangeable supply pack, a pre-mixer outlet for discharging the output into the mixing chamber, and a conduit extending between the pre-mixer inlet and the pre-mixer outlet; wherein the first pre-mixer and/or the second pre-mixer further comprises a water inlet opening into the conduit for feeding into the pre-mixer water supplied from the water pre-chiller.

7: Apparatus as claimed in claim 6, wherein the water inlet opening is orientated to jet inflowing water towards the pre-mixer inlet to thereby flush the outlet of the doser of the exchangeable supply pack.

8: Apparatus as claimed in claim 1, further comprising a pre-chiller cooling circuit for supplying coolant from the cooling unit to the water pre-chiller to cool the water.

9: Apparatus as claimed in claim 8, wherein the pre-chiller cooling circuit comprises a heat exchanger that is cooled by the coolant, wherein the heat exchanger is, or is in thermal contact with, the water pre-chiller.

10: Apparatus as claimed in claim 9, wherein the water pre-chiller and/or heat exchanger is additionally in thermal contact with the beverage concentrate reservoir containing the beverage concentrate.

11: Apparatus as claimed in claim 9, wherein sweetener concentrate reservoir is thermally isolated from the water pre-chiller and/or heat exchanger.

12: Apparatus as claimed in claim 9, wherein the heat exchanger comprises one or more metal, preferably aluminium, blocks, wherein coolant passes through one or more coolant bores in the one or more metal blocks and water passes through one or more water bores in the one or more metal blocks.

13: Apparatus as claimed in claim 12, wherein the beverage concentrate reservoir is in contact with the one or more metal blocks; and optionally wherein the one or more metal blocks are in face-to-face contact with a face of the beverage concentrate reservoir.

14: Apparatus as claimed in claim 1, wherein the mixing chamber comprises an agitator for recirculating beverage liquor standing in the mixing chamber.

15: Apparatus as claimed in claim 1, wherein the mixing chamber is cooled.

16: Apparatus as claimed in claim 1, wherein the apparatus is for preparing an aerated ice-containing tea or coffee beverage and further comprises an aerator, preferably an air pump, for delivering a gas into the beverage liquor.

17: Apparatus as claimed in claim 1, further comprising a second beverage dispensing outlet for dispensing another tea or coffee beverage of a different type; optionally a tea or coffee beverage not containing ice; optionally an aerated tea or coffee beverage not containing ice.

18: Apparatus as claimed in claim 17, wherein both the ice-containing tea or coffee beverage dispensed from the beverage dispensing outlet and the tea or coffee beverage of a different type dispensed from the second beverage dispensing outlet are derived from the beverage liquor output from the mixing chamber.

19: A system comprising the apparatus of claim 1, a beverage concentrate reservoir and a sweetener concentrate reservoir.

20: The system of claim 19, wherein the beverage concentrate reservoir and the sweetener concentrate reservoir each comprise an exchangeable supply pack.
